(19) United States
(12) Patent Application Publication
(10) Pub. No.: US 2024/0420586 A1
(43) Pub. Date: Dec. 19, 2024

(54) AUTOMATED GAMIFICATION METHOD FOR LEARNING MORPHOLOGICALLY RICH LANGUAGES

(71) Applicant: ISTANBUL TEKNIK UNIVERSITESI, Istanbul (TR)

(72) Inventor: Gulsen ERYIGIT, Istanbul (TR)

(73) Assignee: ISTANBUL TEKNIK UNIVERSITESI, Istanbul (TR)

(21) Appl. No.: 18/699,594

(22) PCT Filed: Sep. 28, 2022
(86) PCT No.: PCT/TR2022/051055

§ 371 Date: Apr. 9, 2024

(30) Foreign Application Priority Data
Oct. 12, 2021 (TR) 2021/015850

(51) Int. Cl. G09B 7/02; G06F 40/268; G06F 40/279; G09B 7/06

(52) U.S. Cl. CPC G09B 7/02; G06F 40/268; G06F 40/279; G09B 7/06

(57) ABSTRACT

A morphology learning method of morphologically rich languages is performed via gamification using finite state transducer technology. The method includes grammar exercises specific to MRLs and allows users to observe different grammar/morphology formations on word groups suitable for their level or choice.

### CROSS REFERENCE TO RELATED APPLICATIONS

This application is a national stage entry of International Application No. PCT/TR2022/051055, filed on Sep. 28, 2022, which is based upon and claims foreign priority to Turkey Patent Application No. 2021/015850, filed on Oct. 12, 2021, the entire contents of which are incorporated herein by reference.

### TECHNICAL FIELD

The invention relates to an automated gamification method for complex morphology learning using finite state transducer technology.

### BACKGROUND

Today, studies in the field of language learning are mostly for English. Since almost all of these applications have been developed primarily for English, the exercise types they offer are insufficient for Turkish and similar morphologically rich languages (hereinafter referred to as MRL) (Finnish, Hungarian, Japanese, Korean, etc.). Generating an exercise in teaching the complex word level grammar structure of morphologically rich languages (for example: Turkish “kedilerimizden” (“from our cats”), “gidebiliyormuşum” (“I have been able to go”)) to foreign language learners is a manual process. For this reason, there is a learning process in which a sufficient amount of examples are not presented to the students, students cannot practice enough and cannot test themselves, and this creates great difficulties for individuals who are trying to learn MRLs as a foreign language.

The most important feature that distinguishes MRLs from other languages is that a significant part of grammatical information is coded at the word level. For this reason;
The average number of words in sentences is less than the other languages which are not morphologically rich
Due to the diversity of grammatical information coded in words, it is possible to see a word in hundreds of different surface forms in natural language flow. (For example, while the word “cat” in English can only be seen in the singular and plural form and the possessive form of the noun with the “'s” suffix, the same word can be seen in hundreds of different surface forms in Turkish. (E.g. kedilerimizdekilerden (from those in our cats)).
The word/constituent order in MRLs is very flexible compared to other languages.

Because of all these features, it is necessary to determine different strategies in the teaching of MRLs and Computer Assisted Language Learning (CALL) and Mobile Assisted Language Learning (MALL) applications developed for MRLs.

It has been observed that some of these applications used in the art only contain exercises for word or sentence repetition (memorization, remembering), while some of them offer their users grammar exercises (not having enough variety) that were previously prepared manually by human. It is seen that the exercise types provided in these applications cannot go beyond the exercise types developed for English. In these applications, sentences and words that are not very meaningful in the target language but are repeated over and over due to the limited number of examples are generally shown to the users. Since the complex morphology in MRLs contains many details, the exercises are only simple structures (for example: possessive, and plural forms) and the exercise types containing their combinations cannot be added and it is not presented with appropriate exercises.

Therefore, there are some deficiencies such as sentences with limited words and structures, lack of grammar exercises specifically designed for MRLs (low level of complexity of the morphology in exercises, less variety of exercise types), systems that do not allow the user to observe different grammatical/morphological formations on the word groups they want to practice and showing misalignments due to automatic translations in applications taking also the source language into account in addition to the target language (e.g.: ‘kitabιmdan (of my book)’ aligned with only the word ‘book’, production of exercises for directly matching a Turkish word with suffix with an English word stem).

The US patent document numbered U.S. Pat. No. 5,625,554, which is in the state of the art, discloses databases to be used in computer aided devices for text indexing and receiving, and methods for creating databases.

The US patent document numbered U.S. Pat. No. 7,398,197, which is in the state of the art, discloses the systems and methods used to create weighted finite state machines to represent grammars.

The US patent document numbered US2002128818, which is in the state of the art, discloses the system and method created to answer the questions asked about the language in the most correct way.

When the existing methods in the art were examined, it was necessary to realize a method in which the complex morphology learning of MRLs is performed via gamification.

### SUMMARY

The object of this invention is to realize a method in which the complex morphology learning of MRLs is performed via gamification.

Another object of this invention is to realize a gamified morphology learning method for MRLs, which allows users to observe MRL-specific grammar exercises with various grammar/morphology phenomena appropriate to their language level or choice.

### DETAILED DESCRIPTION OF THE EMBODIMENTS

The invention relates to a method in which the morphology learning of MRLs is performed via gamification, comprising the following steps:
Compiling the morphological structures used in language learning,
Sorting and leveling the compiled morphological structures in accordance with language teaching (curriculum),
Creating a word list containing the word stems and classes to be used in the exercises for the target language level,
The vocabulary to be used in the game interface and the clue words within the games are selected.
Integrating a finite state transducer that can analyze words in terms of morpheme and synthesize the words analyzed in terms of morpheme,
Generating multiple choice or short answer input type exercises automatically by using word list and finite state transducers, in which morphological structures will be presented to the learner gradually, by grouping them under different levels, first in single and then in different combinations,
Checking the answers given by the learner automatically and giving feedback on the correctness of the answers,
Presenting the exercises and feedback in a gamified environment in which the learners can follow their progress (e.g. scoring, leaderboard, and levels).

In the method of the invention, first of all, the basic grammar topics embedded at the word level to be used in language learning are determined. For example, singularity/plurality, case, and possessive for nouns, tense, person structures or negation, question, verb moods, and similar structures for verbs can be selected. For the morphological structures used in the method, the morphological components are determined as follows.
noun plurality marker (e.g. -ler/lar (-s)),
noun case markers (e.g. -i for accusative, -de for locative, -e for dative, -den for ablative, -in for genitive),
noun possessive markers (e.g. 1., 2., and 3.-person singular and plural markers),
verb present continuous tense markers (for 1., 2., and 3. person singular and plural)
verb past tense markers (for 1., 2., and 3. person singular and plural)
verb future tense markers (for 1., 2., and 3. person singular and plural)
verb present tense markers (for 1., 2., and 3. person singular and plural)

Sorting and leveling of the compiled morphological structures in accordance with language teaching (curriculum) are carried out by experts separately for each MRL. If available, ready-made language learning curricula are used during this process. For example, the curricula for learning Turkish as a native language or a foreign language are published separately by the T. R. Ministry of National Education. In the method, if available, these curricula are reviewed and the morphological structures are selected and used in the same order. For example, it is determined at this stage that the present continuous tense structure will be taught before the past tense structure for verbs in Turkish learning. A word list containing the word stems and classes to be used in the exercises for the target language level is created. These word lists are compiled using the word lists suitable for the target language levels in the literature for the relevant MRL. For example, the A1 level is defined as the beginner level in language learning in the literature, and the word lists of this level can be used directly in the beginner level exercises in the method. The main words and clue words to be used in the interaction interface are determined. These words are the words displayed in the application interface for the learners to understand what to do in the relevant exercise. For example, the clue words such as “present continuous tense”, “-i for accusative”, “benim” (my), “senin” (your) are used to guide the learner.

A finite state transducer is integrated, which can analyze words in terms of morpheme and synthesize the words analyzed in terms of morpheme. The basic structure of the finite state transducer integration can be summarized as follows. All the words (lexicon) of the language and morpheme rules of the language are coded by experts on a finite state transducer (which can be considered a bidirectional finite state automat) architecture. For such an input word, it is possible to analyze the stem of the word and its suffixes.

For example: When the input word “okullarιmιz” (“our schools”) is given to such a morphological analyzer, the analysis “okul(school)+Noun+A3pl+P1pl+Nom” can be produced. This analysis is a kind of machine readable representation of the word's stem, parts-of-speech tag (e.g. Noun, verb, etc.), and labels for suffixes attached to this stem (e.g. A3pl-plural suffix, P1pl-1. person plural possessive suffix, Nom-nominative) of the word category of the word and the suffixes of this stem. These codes are not displayed in the program interface, they are only used during implementation at background.

In addition, due to these integrations, as a result of the same or similar finite-state machines running in the reverse direction, it is possible to take the morphological analysis as input and produce/synthesize the word in natural language as output.

For example, when “okul (school)+Noun+A3pl+P2pl+Acc” is given to the system, the system can generate the word “okullarιnιzι” (“your schools)” by taking into account all the sound rules of the language and the coded exceptions. (In the example, P2Pl-2. person plural possessive suffix expresses Acc-i accusative suffix.)

The finite state transducers are used in the method for dynamic exercise generation. For example, while the “plural” structure exercise is automatically created for the word “hour” chosen randomly from the word list, the multiple choice options “saatler” and “saatlar” are automatically created, and the correct one (‘‘saatler’ hours) of these options is determined instantly by the finite state transducers. Similarly, in the automatic generation of the “possessive” structure exercise for the same word, different person possessive suffixes such as “saatim” (“my clock”), “saatleri” (“their clocks”), “saatimiz” (“our clock”), etc. are also automatically generated by finite state transducers and the learner is expected to choose the 1. person singular possessive case.

The multiple choice or short answer input type exercises are generated automatically by using the word list and finite state transducers, in which morphological structures will be presented to the learner gradually, by grouping them under different levels, first in single and then in different combinations.

The answers given by the learner are checked automatically and feedback is given on the correctness of the answers. For example, when the user chooses the wrong answer in multiple choice questions, the correct answer to be chosen and where his/her mistakes are shown before proceeding to the next question. At this stage, incorrect and correct answers are displayed at the same time and the part where the user made a mistake is highlighted to support the learning. Similarly, in short answer input type exercises, the answer written by the learner is automatically compared with the correct answer and if it is incorrect, the same feedback is given.

The exercises and feedback are presented to the user in a gamified environment in which the learner can follow the progress (e.g. scoring, leaderboard, and levels).

In an exemplary embodiment of the method of the invention, an exercise with 10 levels is constructed. Each level includes multiple choice or short answer input type exercises.

Level 1 is the easiest level and includes 4 multiple choice exercises on plurality, case, possessive markers, and present continuous tense markers. Level 2 includes short answer input type questions. The levels increase in this way and at each level, the exercises are presented to the user in different question types and subjects.

With the method of the invention,
It is possible to create numerous examples with the ability to generate automatic exercises instead of manually created exercises with limited words and structures for learning MRLs.
It is possible to eliminate the deficiencies of grammar exercises that are not specially designed for MRLs. (The level of morphological complexity of the exercises can be adjusted, and the variety of exercise types can be increased.)
Approaches are presented that allow the user to observe different grammatical/morphological formations on the word groups they want.

1. A method in which a morphology learning of morphologically rich languages is performed via gamification, comprising:
compiling morphological structures used in language learning, and
sorting and leveling the compiled morphological structures in accordance with language teaching, the sorting and leveling comprising:
creating a word list containing word stems and classes to be used in the exercises for a target language level,
determining the main words and clue words to be used in an interaction interface,
integrating a finite state transducer that analyzes words in terms of morpheme and synthesize the words analyzed in terms of morpheme,
generating multiple choice or short answer input type exercises automatically by using word list and finite state transducers, in which morphological structures will be presented to a learner gradually, by grouping them under different levels, first in single and then in different combinations, and
checking answers given by the learner automatically and giving feedback on the correctness of the answers.

2. The method according to claim 1 in which the morphology learning of morphologically rich languages is performed via gamification, wherein the exercises and feedback are presented in a gamified environment in which the learner follows progress.
